(19) United States
(12) Patent Application Publication
(10) Pub. No.: US 2013/0318972 A1
(43) Pub. Date: Dec. 5, 2013

(54) GAS TURBINE APPARATUS WITH IMPROVED EXERGY RECOVERY

(71) Applicants: Iain Neill, Stockton-on-Tees (GB); Darren Watson, Leeds (GB)

(72) Inventors: Iain Neill, Stockton-on-Tees (GB); Darren Watson, Leeds (GB)

(21) Appl. No.: 13/812,738

(22) PCT Filed: Aug. 4, 2011
(86) PCT No.: PCT/GB2011/051480

§ 371 Date: Mar. 25, 2013

(30) Foreign Application Priority Data
Aug. 4, 2010 (GB) 1013061.5

(51) Int. Cl. F02C 3/04

(52) U.S. Cl. CPC F02C 3/04
USPC 60/726

(57) ABSTRACT

A gas turbine apparatus comprising a compressor adapted to compress air; a combustion chamber, disposed downstream of the compressor and adapted to receive and combust a first portion of the compressed air is disclosed. The gas turbine apparatus further comprises a turbine, disposed downstream of the combustion chamber and adapted to receive and perform work from the combusted and compressed air, and a heat exchanger comprising a cooler, disposed parallel to the combustion chamber, downstream of the compressor and upstream of the gas turbine, which is adapted to receive and cool at least a second portion of the compressed air and provide the cooled compressed air to at least one thermally loaded part of the gas turbine. In addition, the gas turbine apparatus comprises at least one super-heater assembly, disposed downstream of the compressor and upstream of the cooler, adapted to extract and transfer energy from the compressed air to the combustion chamber and/or the turbine and/or an auxiliary energy recovering system, utilizing at least one auxiliary working medium adapted to transfer the energy.

The present invention relates to gas turbines and in particular to gas turbines with an improved heat exchanger assembly for recovering exergy in a gas turbine.

### INTRODUCTION

A gas turbine, also called combustion turbine, is an engine that creates a flow of combusted gas and extracts energy or power from it. With reference to FIG. 1, a typical gas turbine has an upstream compressor 2 that is coupled to a downstream turbine 7 and a combustion chamber 5 disposed in-between. Energy is added to a compressed air stream 3 in the combustor 5, where fuel is mixed with air 4 and ignited. In the high pressure environment of the combustor 5, combustion of the fuel produces high temperature gas 6 which is forced into the turbine section 7. There, the hot gas flow is directed over the turbine's blades, spinning the turbine 7 which powers the compressor 2 and generator 16 via a shaft 14. Various gas turbine designs pass some of the compressed air stream 9 through external heat exchangers 100 to cool the air before it is introduced into the portions of the gas combustor or turbine hot section for cooling and other purposes.

In the present state of the art, the heat extracted from cooling the compressed air is either discharged to atmosphere or utilized in order to produce steam from water or used to heat the fuel for the combustion process via a fuel heater. Typical examples for a cooling system 100 are shown in FIGS. 2(a) to (d), where the compressed air is either cooled by an air-to-air cooler 10, or the energy extracted from the compressed air is utilized in, for example, a kettle boiler 17 or a steam generator 26. A fuel heater 28, as shown in FIG. 2(c), may also be used to pre-heat the fuel for the combustion chamber in order to improve the thermal efficiency of the gas turbine. Here, heat is extracted from the compressed air 9 and fed, carried by the fuel, into the combustion chamber 5. However, depending on how the fuel and air cycles match, the thermal capacity of the fuel combined with limits on maximum fuel temperature can often restrict the proportion of the heat which can be transferred to the fuel, therefore wasting the benefit of an amount of the energy carried by the cooling air. In many practical applications, other sources of waste heat are also available which are better matched to heating fuel and if used will provide an advantage in minimizing the exergy destruction of the overall system.

In thermodynamics, the exergy of a medium can be defined as the maximum useful work possible during a process that brings the system into equilibrium with a heat reservoir. Exergy destruction is therefore a decrease in the maximum useful work available to be converted from heat to work elsewhere in the process and loss of efficiency in the overall heat to work conversion process.

In the case of the air cooler in FIG. 2(a), all exergy in the compressed air is destroyed by the exchanger 25 leading to a loss of efficiency in the overall system. In the case of the kettle boiler 17 in FIG. 2(b) a substantial amount of exergy is destroyed in the heat exchange process as steam is generated from water by evaporation at constant pressure and temperature, thus having a low mean temperature of heat addition and low resultant exergy. The use of a steam generator 26 in FIG. 2(d) is only a slight improvement on the kettle boiler 17 and still destroys an important amount of exergy.

Accordingly, it is an object of the present invention to minimize the exergy destruction and therefore allow a larger proportion of the exergy in the compressed air to be transferred to the cooling medium in order to be converted to work or used as an energy source elsewhere in the process, while maintaining the function of temperature control of the compressed air stream.

### SUMMARY OF THE INVENTION

Preferred embodiments of the invention seek to overcome one or more of the above disadvantages of the prior art.

According to a first aspect of the present invention, there is provided a gas turbine apparatus comprising:
a compressor adapted to compress air;
a combustion chamber, disposed downstream of said compressor and adapted to receive and combust a first portion of said compressed air;
a turbine, disposed downstream of said combustion chamber and adapted to receive and perform work from said combusted and compressed air;
a heat exchanger system comprising a cooler, disposed parallel to said combustion chamber, downstream of said compressor and upstream of said gas turbine, adapted to receive and cool at least a second portion of said compressed air and provide said cooled compressed air to at least one thermally loaded part of said gas turbine, and
further comprising at least one super-heater assembly, disposed downstream of said compressor and upstream of said cooler, adapted to extract and transfer energy from said compressed air to said combustion chamber and/or said turbine and/or an auxiliary energy recovering system, utilizing at least one auxiliary working medium adapted to transfer said energy.

The gas turbine apparatus may further comprise at least one bypass, disposed downstream of said compressor and parallel to said super-heater assembly, utilised to limit the temperature differential across the heat exchanger system to a predetermined value depending on the temperature requirements of the gas turbine hot section.

According to a second aspect of the present invention, there is provided a gas turbine apparatus comprising:
a compressor adapted to compress air;
a combustion chamber, disposed downstream of said compressor and adapted to receive and combust a first portion of said compressed air;
a turbine, disposed downstream of said combustion chamber and adapted to receive and perform work from said combusted and compressed air;
a heat exchanger system comprising a cooler, disposed parallel to said combustion chamber, downstream of said compressor and upstream of said gas turbine, adapted to receive and cool at least a second portion of said compressed air and provide said cooled compressed air to at least one thermally loaded part of said gas turbine, and
further comprising at least one super-heater assembly, disposed downstream of said compressor and upstream of said cooler, adapted to extract and transfer energy from said compressed air to said combustion chamber and/or said turbine and/or an auxiliary energy recovering system, utilizing at least one auxiliary working medium adapted to transfer said energy, and
further comprising at least one bypass, disposed downstream of said compressor and parallel to said super-heater assembly, utilised to limit the temperature differential across the heat exchanger system to a predetermined value depending on the temperature requirements of the gas turbine hot section.

The above two aspects of the present invention provide the advantage that, compared to all forms of existing art, the present invention allows a larger proportion of the exergy in the compressed air to be transferred to the cooling medium in order to be converted to work or used as an energy source elsewhere in the process, while maintaining the function of temperature control of the compressed air stream.

In particular, the bypass further provides the advantage that the process does not require the super-heater assembly to be warmed-up with steam prior to the start up.

The super-heater assembly may extract at least half (50%) of the total energy transferred by said second portion of said compressed air. Advantageously, at least 50% of the heat captured from the compressed air may be captured as sensible heat in the working medium. Here, sensible heat is defined as heat energy of a material that is related to a change in temperature without a change in state. Preferably, at least 60% of the heat captured from the compressed air may be captured as sensible heat in the steam and/or fuel. More preferably, at least 70% of the heat captured from the compressed air may be captured as sensible heat in the steam and/or fuel. Even more preferably, at least 80% of the heat captured from the compressed air may be captured as sensible heat in the steam and/or fuel. Even more preferably, at least 90% of the heat captured from the compressed air may be captured as sensible heat in the steam and/or fuel, and even more preferably, 100% of the heat captured from the compressed air may be captured as sensible heat in the steam and/or fuel. This provides the advantage that all of the energy removed from the compressed air that is recovered to a working medium, is transferred with maximum exergetic efficiency. For example, the apparatus may be adapted to use the compressed air to pre-heat (super-heat) steam to a predetermined temperature and then used for super-heating fuel and/or generating steam from water for use in the gas turbine or alternative energy conversion systems. The apparatus may also be used for super-heating steam, followed by heating water to an optimal temperature. The super-heated steam output of the exchanger may be used as input for steam injection into the combustion chamber, or alternatively into a steam turbine or any other plant or process that uses steam to generate electrical power or for other uses.

Alternatively, the heat exchanger assembly may comprise at least one super-heater, or a plurality of super-heaters arranged in a parallel configuration utilizing said at least one auxiliary working medium at pressures and temperatures which are optimized for maximum exergy capture. This provides the advantage that multiple individual heat exchangers are lighter than a single unit and has the further advantages that there is less internal expansion associated with the device during changes in temperature and less warm up required during start up and load changes.

The heat-exchanger assembly may comprise a plurality of super-heaters arranged in a series configuration, each of said plurality of super-heaters utilizing said at least one auxiliary working medium at pressures and temperatures which are optimized for maximum exergy capture.

Any one of said plurality of super-heater disposed upstream of any one of the other said plurality of super-heater may be adapted to receive said at least one auxiliary working medium from at least one of the other said plurality of super-heaters.

The gas turbine apparatus may further comprise a fuel-heater disposed upstream or downstream of said super-heater assembly and adapted to extract heat from said second portion of said compressed air for heating fuel of said combustion chamber. The heat exchanger may be either one of an air cooler, a boiler, a steam generator or any combination thereof. Whether stand-alone or integrated into a combined cycle or other process. This provides the advantage of maximising the exergetic efficiency of the gas turbine apparatus and related processes.

The auxiliary working medium may be steam, saturated steam, water or fuel. This provides the advantage that a commonly available working medium is used.

The bypass of the first and second aspect of the present invention may comprise a bypass-valve disposed upstream of and adapted to selectively bypass said super-heater assembly and said heat exchanger, routing at least part of said second portion of said compressed air to said gas turbine. This provides the advantage that a maximum predetermined temperature differential can be ensured and maintained during or prior to operation. This provides the additional advantage that the final temperature of the cooling air may be increased if the heat exchanger operation leads to over-cooling of the compressed air.

### BRIEF DESCRIPTION OF THE DRAWINGS

A preferred embodiment of the present invention will now be described, by way of example only and not in any limitative sense, with reference to the accompanying drawings, in which:

FIG. 1 shows a schematic diagram of a typical combustion gas turbine including a compressor, combustor, turbine and cooler arrangement,

FIGS. 2(a) to (d) shows detailed schematic diagrams of various examples for the cooler arrangement of FIG. 1, including (a) an air-to-air cooler, (b) a kettle boiler, (c) a fuel heater, and (d) a steam generator;

FIG. 3 shows a schematic diagram of a cooler arrangement of a first embodiment of the present invention including a super-heater and an air-to-air cooler or alternative heat exchanger,

FIG. 4 shows a schematic diagram of a cooler arrangement of a second embodiment of the present invention including two super-heaters arranged in parallel and an air-to-air cooler or alternative heat exchanger,

FIG. 5 shows a schematic diagram of a cooler arrangement of a third embodiment of the present invention including two super-heaters arranged in series and a kettle boiler or alternative heat exchanger,

FIG. 6 shows a schematic diagram of a cooler arrangement of a fourth embodiment of the present invention including a super-heater and a steam generator or alternative heat exchanger,

FIG. 7 shows a schematic diagram of a cooler arrangement of a fifth embodiment of the present invention including two super-heaters and a water heater or alternative heat exchanger, and

FIG. 8 shows a schematic diagram of a cooler arrangement of a sixth embodiment of the present invention which includes two super-heaters and a steam generator or alternative heat exchanger.

### DETAILED DESCRIPTION OF EMBODIMENTS

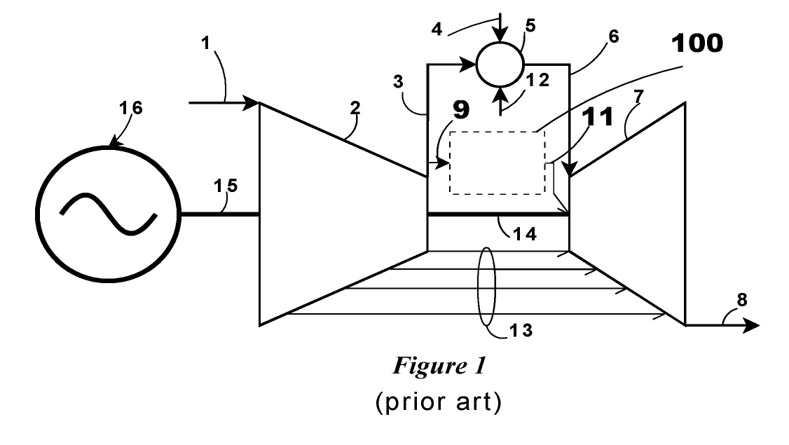

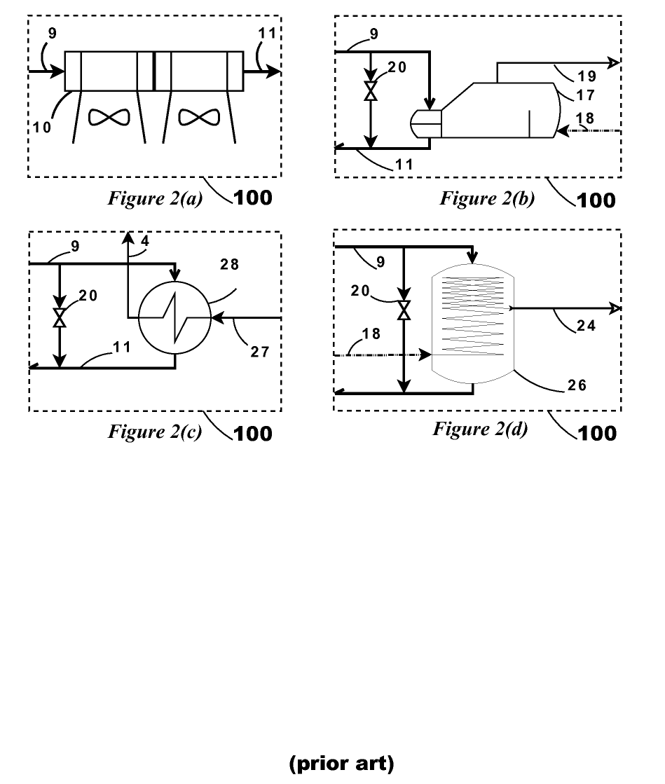

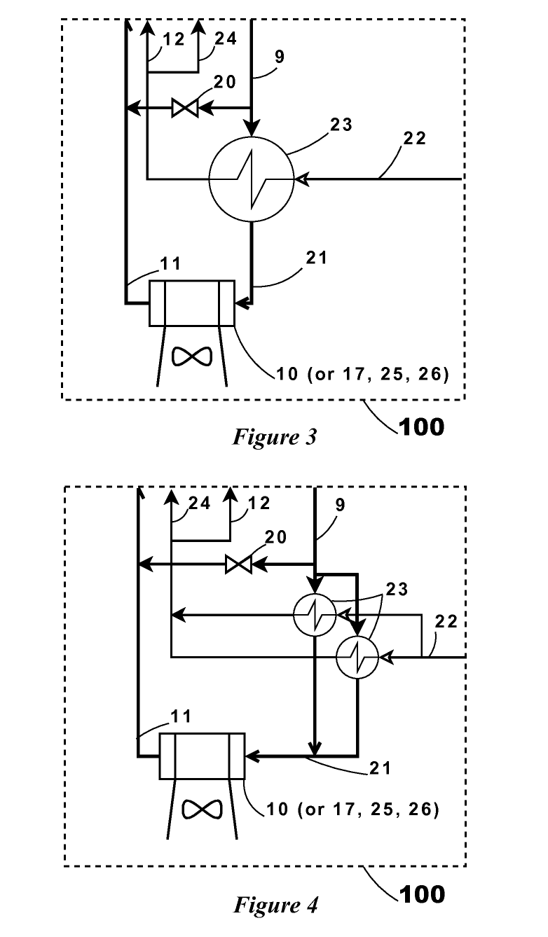

Referring to FIG. 3, an example of a first embodiment of the invention is disclosed showing only the gas turbine cooling system according to the gas turbine apparatus disclosed in FIG. 1. The first embodiment of the present invention includes a super-heater stage, comprising a heat exchanger 23 in form of a super-heater, upstream of a temperature control stage, comprising an air-to-air cooler 10. A portion of the compressed air 9 is extracted from the compressor 2 and cooled via heat exchanger 23. The heat exchanger 23 provides its own working medium 22 and may be a shell and tube tube-sheet type, a shell and tube header type, a plate heat exchanger, a compact exchanger or any other heat exchanger adapted to cool the compressed air. The working medium 22 could be saturated steam, but any other working medium such as air, super-heated steam, fuel or any other fluid may be used. In operation, the steam 22 is heated by the high-temperature compressed air 9 in the heat exchanger 23 producing a super-heated steam that is discharged via stream 12 to, for example, the combustor 5 and/or via stream 24 to other energy recovering equipment where the heat is converted into other forms of energy. The super-heated steam discharged through stream 12 may also be used for cooling thermally loaded parts of the turbine 7, for chemical processes, or fed back into the turbine 5. The super-heater stage allows that at least half (50%) of the heat provided by the compressed air 9 to be transferred to the working medium 22. That means that at least half (50%) of the heat is used to super-heat the working medium 22. Cooled compressed air 21 is then discharged from the heat exchanger 23 of the super-heater-stage and fed into an air-to-air cooler 10. The air-to-air cooler 10 provides further cooling of the discharged compressed air 21 and allows temperature control of the cooled air temperature. Instead of the air-to-air cooler 10, any other suitable heat exchanger, such as a boiler 17 or a super-heater 23 or a water heater 25 or a steam generator 26 or a heater with an alternative working medium may be used.

Alternatively, the gas turbine apparatus may further comprise a final heat exchanger which extracts no more than half (50%) of the total energy transferred by the second portion 9 of the compressed air. The type of equipment to be utilised is similar to the prior art, however, the compressed air when it is being cooled in the final heat exchanger device has a lower exergy content than in the prior art which provides the advantage that the exergy is transferred with higher effectiveness. Therefore, this final heat exchanger maintains the temperature control of the cooled air over the entire operating range of the gas turbine.

A bypass valve 20 couples the input stream 9 of the compressed air with the output stream 11 of the compressed air so that the temperature differential between the input stream 9 and the output stream 11 can be kept at a predetermined maximum without the need to heat up the heat exchangers prior to operation and otherwise increasing if the final heat exchanger operation leads to over-cooling of the compressed air therefore ensuring efficient operation of the gas turbine apparatus.

Referring now to FIG. 4, a second embodiment of the invention includes at least two heat-exchangers 23 in form of super-heaters arranged in a parallel configuration and operating at the same pressure and temperature conditions of the working medium 22. Here, steam 22 is simultaneously super-heated by the heat exchangers 23 to a predetermined temperature and discharged via stream 12 and/or stream 24. Stream 12 may lead to the combustor 5 or turbine 7, or may be used for cooling thermally loaded parts of the turbine 7, fed to a steam turbine or for other uses. Stream 24 may lead to any other energy recovering equipment where the heat is converted into other forms of energy. The cooled compressed air 21 is then discharged from the two heat exchangers and simultaneously fed into an air-to-air cooler 10. The air-to-air cooler 10 provides further cooling of the discharged compressed air 21 and allows temperature control of the turbine cooling air temperature. Instead of the air-to-air cooler 10, any other suitable heat exchanger, such as a boiler 17 or a super-heater 23 or a water heater 25 or a steam generator 26 or a heater with an alternative working medium may be used. Pressure and temperature conditions of the working medium may also be optimised separately to maximise the transfer of exergy in the energy recovered from the compressed air.

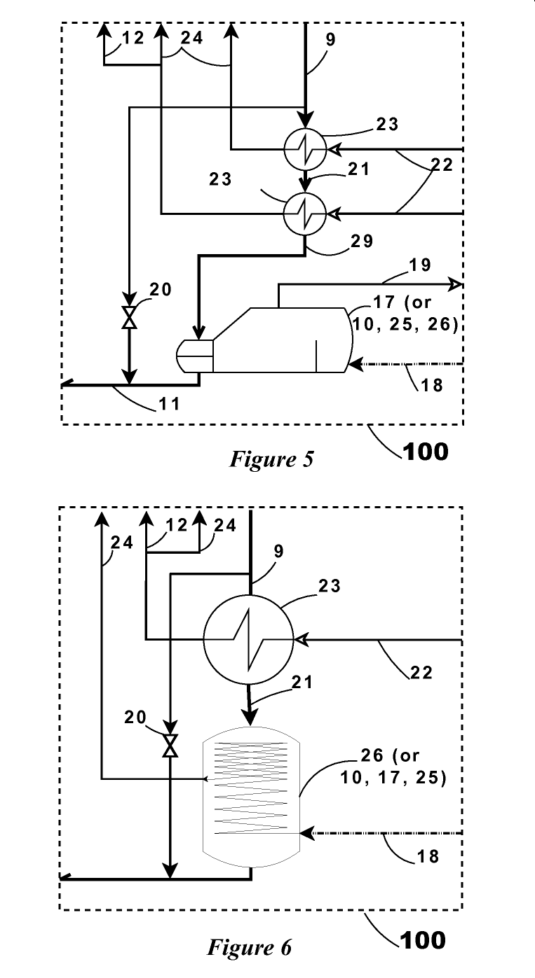

In an alternative third embodiment, as shown in FIG. 5, at least two heat-exchangers 23 in form of super-heaters are arranged in a series configuration each of the heat-exchangers 23 optionally operating at a different pressures and/or temperatures of the working medium 22. In this particular example, the incoming compressed air 9 streams to the first super-heater 23 then to the second super-heater, downstream from the first super-heater. The discharged super-heated steam is used for other equipment on, for example, a plant via streams 24. Optionally, the discharged super-heated steam is used for steam injection to the combustor 5 via stream 12. Here, the steam streams 12 and 24 are suitably used according to the plant requirements. The boiler 17 provides further cooling of the discharged compressed air 21 and allows temperature control of the cooled air temperature. Instead of the boiler 17, any other suitable heat exchanger, such as a air-to-air cooler 10 or another super-heater 23 or a steam generator 26 or a water heater 25 or a heater with an alternative working medium may be used.

FIG. 6 shows a fourth embodiment of the present invention where the downstream heat exchanger is a once-though steam generator 26 that provides additional super-heated steam to any one of the other energy recovering equipment via stream 24. Here, the steam generator 26 is supplied with feed water via stream 18. Instead of the steam generator 26, any other suitable heat exchanger, such as a air-to-air cooler 10 or a boiler 17 or another super-heater 23 or a water heater 25 or a heater with an alternative working medium may be used.

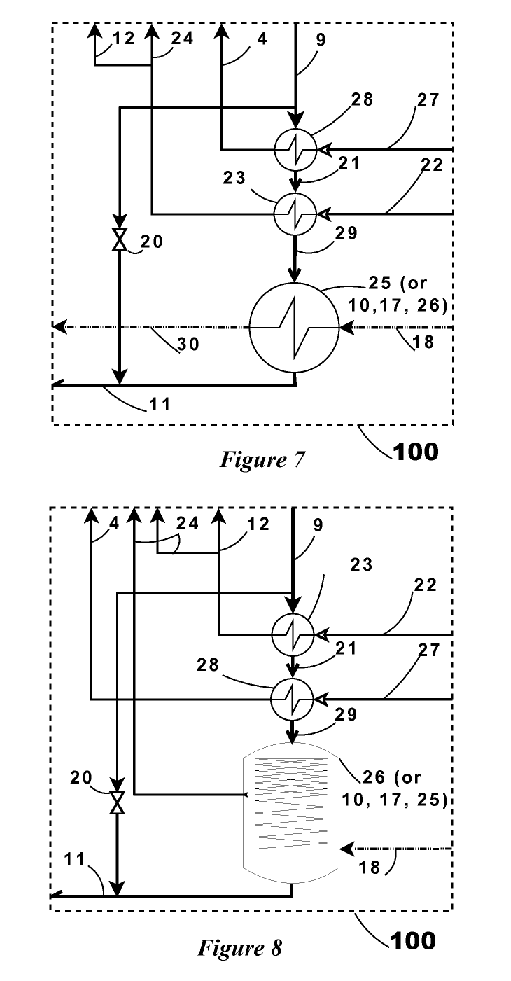

Referring to FIG. 7, a further alternative embodiment of the present invention is disclosed including an additional fuel or steam super-heater 28 upstream of any one of the embodiments previously described. In particular, fuel or steam 27 is heated by the heat exchanger 28 using heat from the hot compressed air 9 in order to provide an increase in super-heat of the working medium 4. The cooler compressed air 21 is then fed through heat exchanger 23 to provide super-heated steam via streams 12 and/or 24, wherein the input stream of the working medium is cold superheated steam 22 and/or mixed with saturated steam 19 that is provided by a water heater 25 disposed downstream of heat exchanger 23. Instead of the water heater 25, any other suitable heat exchanger, such as an air to air cooler 10 or a boiler 17 or another super-heater 23 or a steam generator 26 or a heater with an alternative working medium may be used.

Alternatively, as shown in FIG. 8, the fuel heater or steam super-heater 28 is disposed in-between heat exchangers 23 and 17. In particular, the input stream of the working medium is cold superheated steam 22 and/or mixed with saturated steam 19, provided by heat exchanger 17 and disposed downstream of heat exchanger 28, and which is then fed through heat exchanger 23 to provide super-heated steam via streams 12 and/or 24 using heat from the hot compressed air 9. The cold fuel or super-heated steam 27 is heated by the heat exchanger 28 using heat from the first stage cooled compressed air 21 in order to provide an increase in super-heat of the working medium 4. The cooler compressed air 29 is then fed through steam generator 26 disposed downstream of heat exchanger 28. Instead of the steam generator 26, any other suitable heat exchanger, such as an air-to-air cooler 10 or a boiler 17 or another super-heater 23 or a water heater 25 or a heater with an alternative working medium may be used.

The examples disclosed in FIGS. 3 to 8 illustrate typical combinations of the cooling system 100 of the gas turbine apparatus of the present invention with single or multi-stage super-heater devices, where each stage may be one or more heat exchangers of any suitable type comprising any suitable known device for air temperature control.

It will be appreciated by persons skilled in the art that the above embodiment has been described by way of example only and not in any limitative sense, and that various alterations and modifications are possible without departing from the scope of the invention as defined by the appended claims.

1. A gas turbine apparatus comprising:
a compressor adapted to compress air;
a combustion chamber, disposed downstream of said compressor and adapted to receive and combust a first portion of said compressed air;
a turbine, disposed downstream of said combustion chamber and adapted to receive and perform work from said combusted and compressed air;
a heat exchanger system comprising a cooler, disposed parallel to said combustion chamber, downstream of said compressor and upstream of said gas turbine, adapted to receive and cool at least a second portion of said compressed air and provide said cooled compressed air to at least one thermally loaded part of said gas turbine; and
further comprising at least one super-heater assembly, disposed downstream of said compressor and upstream of said cooler, adapted to extract and transfer energy from said compressed air to said combustion chamber and/or said turbine and/or an auxiliary energy recovering system, utilizing at least one auxiliary working medium adapted to transfer said energy.

2. The gas turbine apparatus according to claim 1, further comprising at least one bypass, disposed downstream of said compressor and parallel to said super-heater assembly, utilised to limit the temperature differential across the heat exchanger system to a predetermined value depending on the temperature requirements of the gas turbine hot section.

3. A gas turbine apparatus comprising:
a compressor adapted to compress air;
a combustion chamber, disposed downstream of said compressor and adapted to receive and combust a first portion of said compressed air;
a turbine, disposed downstream of said combustion chamber and adapted to receive and perform work from said combusted and compressed air;
a heat exchanger system comprising a cooler, disposed parallel to said combustion chamber, downstream of said compressor and upstream of said gas turbine, adapted to receive and cool at least a second portion of said compressed air and provide said cooled compressed air to at least one thermally loaded part of said gas turbine;
further comprising at least one super-heater assembly, disposed downstream of said compressor and upstream of said cooler, adapted to extract and transfer energy from said compressed air to said combustion chamber and/or said turbine and/or an auxiliary energy recovering system, utilizing at least one auxiliary working medium adapted to transfer said energy; and
further comprising at least one bypass, disposed downstream of said compressor and parallel to said super-heater assembly, utilised to limit the temperature differential across the heat exchanger system to a predetermined value depending on the temperature requirements of the gas turbine hot section.

4. The gas turbine apparatus of claim 1, wherein said super-heater assembly extracts at least half of the total energy transferred by said second portion of said compressed air.

5. The gas turbine apparatus of claim 1, wherein said super-heater assembly comprises at least one superheater.

6. The gas turbine apparatus of claim 1, wherein said super-heater assembly comprises a plurality of superheaters arranged in a parallel configuration utilizing said at least one auxiliary working medium at the same pressure and temperature.

7. The gas turbine apparatus of claim 1, wherein said super-heater assembly comprises a plurality of super-heaters arranged in a series configuration, each of said plurality of superheaters utilizing said at least one auxiliary working medium at a different pressure and temperature.

8. The gas turbine apparatus of claim 7, wherein any one of said plurality of super-heaters disposed upstream of any one of the other said plurality of super-heaters is adapted to receive said at least one auxiliary working medium from at least one of the other said plurality of super-heaters.

9. The gas turbine apparatus of claim 1, further comprising a fuel-heater disposed upstream of said super-heater assembly and adapted to extract heat from said second portion of said compressed air for heating fuel of said combustion chamber.

10. The gas turbine apparatus of claim 1, wherein said heat exchanger is either one of an air cooler, a kettle boiler, a steam generator or any combination thereof.

11. The gas turbine apparatus of claim 1, wherein said auxiliary working medium is saturated steam.

12. The gas turbine apparatus of claim 2, wherein said bypass comprises a bypass-valve disposed upstream of and adapted to selectively bypass said super-heater assembly and said heat exchanger, routing at least part of said second portion of said compressed air to said gas turbine.
